(19) United States
(12) Patent Application Publication
(10) Pub. No.: US 2020/0002473 A1
(43) Pub. Date: Jan. 2, 2020

(54) STYRYL SILOXY POLYPHENYLENE ETHER RESIN, PREPARATION METHOD THEREFOR AND APPLICATION THEREOF

(71) Applicant: Shengyi Technology Co., Ltd., Guandong (CN)

(72) Inventors: Chane YUAN, Guangdong (CN); Hongyun LUO, Guangdong (CN); Huayong FAN, Guangdong (CN); Wei LIN, Guangdong (CN)

(21) Appl. No.: 16/465,193

(22) PCT Filed: Mar. 14, 2017
(86) PCT No.: PCT/CN2017/076527

§ 371 Date: May 30, 2019

(30) Foreign Application Priority Data
Dec. 2, 2016 (CN) 201611095529.1

(51) Int. Cl. C08G 65/48; C08J 5/24; C08K 3/016; C08K 5/00; C08K 3/013; C08K 5/14; C08L 71/12

(52) U.S. Cl. CPC C08G 65/485; C08J 5/24; C08K 3/016; C08K 5/0066; C08L 83/04; C08K 5/14; C08L 71/126; C08L 2201/02; C08L 2203/20; C08K 3/013

(57) ABSTRACT

A styryl siloxy polyphenylene ether resin, a preparation method therefor and an application thereof. The styryl siloxy polyphenylene ether resin is obtained by introducing styryl groups and siloxy groups into polyphenylene end groups by means of a simple synthesis method. The resin combines low dielectric property of curing of styryl groups and heat resistance, weather resistance, flame retardancy, dielectric property, and low water absorption of siloxy groups, thereby making better use of the application advantages of polyphenylene ether resins in copper clad laminates and providing excellent dielectric property, moist-heat resistance and heat resistance required by a high-frequency and high-speed copper clad laminate.

### TECHNICAL FIELD

The present invention belongs to the field of copper clad laminates, and relates to a styryl siloxy polyphenylene ether resin, a preparation method therefor and an application thereof.

### BACKGROUND ART

With the increase in the information and communication traffic in recent years, the demand for high-frequency printed circuit boards has increased. In order to reduce the transmission loss in the high-frequency band, electrically insulating materials with excellent electrical characteristics have become the research focus in the field of copper clad laminates. Meanwhile, printed circuit boards or electronic components using these electrically insulating materials require the materials to have a high heat resistance and a high glass transition temperature in order to be able to deal with high-temperature reflow and high-layer assembly at the time of mounting. For these requirements, it has been proposed in many patents to use vinyl benzyl ether compound resin having various chemical structures. In the molecular structure of polyphenylene ether resin there contains a large number of benzene ring structures, and there is no strong polar group, which give the polyphenylene ether resin excellent performances, such as high glass transition temperature, good dimensional stability, small coefficient of linear expansion, low water absorption, especially excellent low dielectric constant and low dielectric loss. In the high-frequency high-speed field, polyphenylene ether resins having vinyl benzyl ether structure have become the preferred resin materials for substrates of high-frequency printed circuit boards because of its excellent mechanical properties and excellent dielectric properties. The polyphenylene ether resins and other resins containing double bonds are used to prepare laminates by radical reaction or self-curing relying on the double bonds of the end group. The obtained laminates have the characteristics of high glass transition temperature, high heat resistance, and high resistance to moisture and heat.

Vinyl benzyl ether compound resins having various chemical structures have been used in the high-frequency high-speed field. Due to better mechanical properties and excellent dielectric properties, polyphenylene ether resins having vinyl benzyl ether structure have increasingly become the preferred resin materials for substrates of high frequency printed circuit boards. At present, the process for preparing vinyl-benzyl-polyphenylene ether compounds involves that, for example, it is known to react, in the presence of alkali metal hydroxides, a polyphenylene ether compound with halogenated methylstyrene (vinylbenzyl halide) in a toluene solution; and then the reaction solution is neutralized with an acid, washed, and reprecipitated with a large amount of methanol (JP Publication No. 2009-96953). As described in CN104072751A, a polyphenylene ether having a phenolic hydroxyl group at the terminal is reacted with a vinylbenzyl halide in the presence of an aqueous solution of an alkali metal hydroxide and a phase transfer catalyst in a solvent comprising an aromatic hydrocarbon and a fatty alcohol; the reactants were washed with an aqueous solution of an alkali metal hydroxide and hydrochloric acid successively to obtain a vinylbenzyl-polyphenylene ether compound. However, it does not disclose the performance improvement of the polyphenylene ether when used in a high-frequency circuit substrate.

It is desirable in the art to obtain a resin material having excellent dielectric properties, heat resistance, flame retardancy and the like by modifying polyphenylene ether resins.

### DISCLOSURE OF THE INVENTION

As to the insufficiencies in the art, the object of the present invention lies in providing a styryl siloxy polyphenylene ether resin, a preparation method therefor and an application thereof. In the styryl siloxy polyphenylene ether resin of the present invention, unsaturated C═C double bonds and siloxy groups are introduced into the side chain of polyphenylene ether resins, so as to make the resins combine low dielectric properties of double-bond curing with heat resistance, weatherability, flame retardancy, dielectric properties and low water absorption of siloxy groups.

The present invention discloses the following technical solutions in order to achieve the object.

On the first aspect, the present invention provides a styryl siloxy polyphenylene ether resin having a structure of Formula (I):

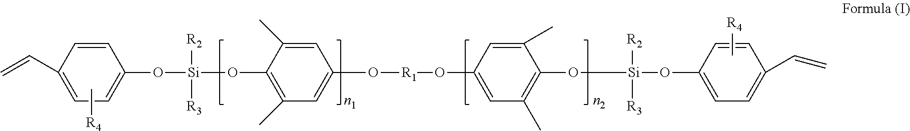

wherein R₁ is

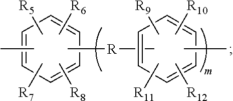

R is a covalent bond or anyone selected from the group consisting of substituted or unsubstituted C₁-C₈ linear chain alkyl groups, substituted or unsubstituted C₁-C₈ branched chain alkyl groups, —O—, —S—,

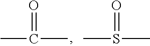

and —SO₂—; R₅, R₆, R₇, R₈, R₉, R₁₀, R₁₁ and R₁₂ are each independently anyone selected from the group consisting of hydrogen, substituted or unsubstituted C₁-C₈ linear chain alkyl groups, substituted or unsubstituted C₁-C₈ branched chain alkyl groups, substituted or unsubstituted C₂-C₁₀ linear chain alkenyl groups, substituted or unsubstituted C₂-C₁₀ branched chain alkenyl groups, and substituted or unsubstituted phenyl group; m is 0 or 1; R₂ and R₃ are each independently anyone selected from the group consisting of substituted or unsubstituted C₁-C₁₀ linear chain alkyl groups, substituted or unsubstituted C₁-C₁₀ branched chain alkyl groups, substituted or unsubstituted C₂-C₁₀ linear chain alkenyl groups, substituted or unsubstituted C₂-C₁₀ branched chain alkenyl groups, substituted or unsubstituted cycloalkyl groups, substituted or unsubstituted aryl groups and substituted or unsubstituted alkylaryl groups; R₄ is selected from the group consisting of hydrogen and any organic groups of C₁-C₂₀ satisfying the chemical environment thereof; n₁ and n₂ are integers greater than 0, satisfying 4≤n₁+n₂≤25.

In the present invention, R is a substituted or unsubstituted C₁-C₈ linear chain alkyl group. That is to say, R could be any of substituted or unsubstituted C₁, C₂, C₃, C₄, C₅, C₆, C₇ or C₈ linear chain alkyl groups, e.g. —CH₂—, —CH₂CH₂—, —CH₂CH₂CH₂— or —CH₂CH₂CH₂CH₂— and the like.

In the present invention, R is a substituted or unsubstituted C₁-C₈ branched chain alkyl group. That is to say, R could be any of substituted or unsubstituted C₁, C₂, C₃, C₄, C₅, C₆, C₇ or C₈ branched chain alkyl groups, e.g.

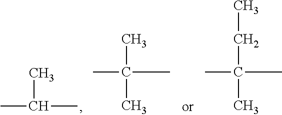

and the like.

In the present invention, R₅, R₆, R₇, R₈, R₉, R₁₀, R₁₁ and R₁₂ are each independently a substituted or unsubstituted C₁-C₈ linear chain alkyl group. That is to say, each of R₅, R₆, R₇, R₈, R₉, R₁₀, R₁₁ and R₁₂ could be any of substituted or unsubstituted C₁, C₂, C₃, C₄, C₅, C₆, C₇ or C₈ linear chain alkyl groups, e.g. —CH₃, —CH₂CH₃, —CH₂CH₂CH₃, —CH₂CH₂CH₂CH₃ or —CH₂CH₂CH₂CH₂CH₃ and the like.

In the present invention, R₅, R₆, R₇, R₈, R₉, R₁₀, R₁₁ and R₁₂ are each independently a substituted or unsubstituted C₁-C₈ branched chain alkyl group. That is to say, each of R₅, R₆, R₇, R₈, R₉, R₁₀, R₁₁ and R₁₂ could be any of substituted or unsubstituted C₁, C₂, C₃, C₄, C₅, C₆, C₇ or C₈ branched chain alkyl groups, e.g.

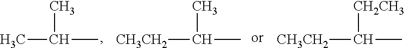

and the like.

In the present invention, R₅, R₆, R₇, R₈, R₉, R₁₀, R₁₁ and R₁₂ are each independently a substituted or unsubstituted C₂-C₁₀ linear chain alkenyl group. That is to say, each of R₅, R₆, R₇, R₈, R₉, R₁₀, R₁₁ and R₁₂ could be any of substituted or unsubstituted C₂, C₃, C₄, C₅, C₆, C₇, C₈, C₉ or C₁₀ linear chain alkenyl groups, e.g. H₂C═CH—, H₃C—HC═CH— or CH₂═CH—HC═CH— and the like.

In the present invention, R₅, R₆, R₇, R₈, R₉, R₁₀, R₁₁ and R₁₂ are each independently a substituted or unsubstituted C₂-C₁₀ branched chain alkenyl group. That is to say, each of R₅, R₆, R₇, R₈, R₉, R₁₀, R₁₁ and R₁₂ could be any of substituted or unsubstituted C₂, C₃, C₄, C₅, C₆, C₇, C₈, C₉ or C₁₀ branched chain alkenyl groups, e.g.

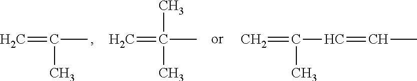

and the like.

Preferably, R₁ is

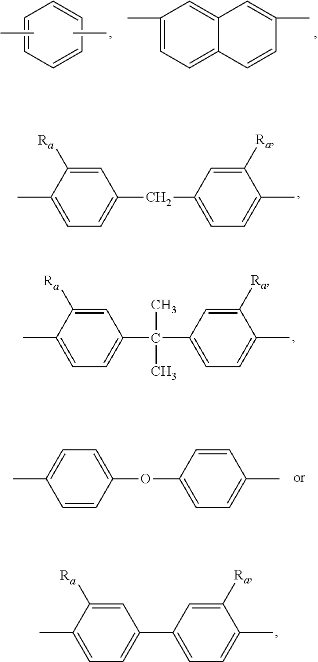

wherein Rₐ is anyone selected from the group consisting of H, allyl and isoallyl.

In the present invention, R₂ and R₃ are each independently a substituted or unsubstituted C₁-C₁₀ linear chain alkyl group. That is to say, each of R₂ and R₃ could be any of substituted or unsubstituted C₁, C₂, C₃, C₄, C₅, C₆, C₇, C₈, C₉ or C₁₀ linear chain alkyl groups, e.g. —CH₃, —CH₂CH₃, —CH₂CH₂CH₃, —CH₂CH₂CH₂CH₃ or —CH₂CH₂CH₂CH₂CH₃ and the like.

In the present invention, R₂ and R₃ are each independently a substituted or unsubstituted C₁-C₁₀ branched chain alkyl group. That is to say, each of R₂ and R₃ could be any of substituted or unsubstituted C₁, C₂, C₃, C₄, C₅, C₆, C₇, C₈, C₉ or C₁₀ branched chain alkyl groups, e.g.

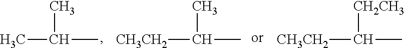

and the like.

In the present invention, R₂ and R₃ are each independently a substituted or unsubstituted C₂-C₁₀ linear chain alkenyl group. That is to say, each of R₂ and R₃ could be any of substituted or unsubstituted C₂, C₃, C₄, C₅, C₆, C₇, C₈, C₉ or C₁₀ linear chain alkenyl groups, e.g. H₂C═CH—, H₃C—HC═CH— or CH₂═CH—HC═CH— and the like.

In the present invention, R₂ and R₃ are each independently a substituted or unsubstituted C₁-C₁₀ branched chain alkenyl group. That is to say, each of R₂ and R₃ could be any of substituted or unsubstituted C₁, C₂, C₃, C₄, C₅, C₆, C₇, C₈, C₉ or C₁₀ ranched chain alkenyl groups, e.g.

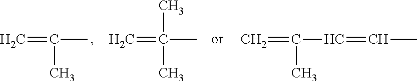

and the like.

In the present invention, R₂ and R₃ are each independently a substituted or unsubstituted cycloalkyl group, preferably a substituted or unsubstituted C₃-C₁₀ (e.g. C₃, C₄, C₅, C₆, C₇, C₈, C₉ or C₁₀) cycloalkyl group, e.g.

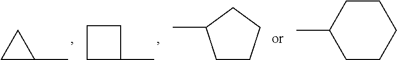

and the like.

In the present invention, R₂ and R₃ are each independently a substituted or unsubstituted aryl group. That is to say, each of R₂ and R₃ could be any of substituted or unsubstituted phenyl group, substituted or unsubstituted naphthyl group, substituted or unsubstituted heteroaryl groups and the like.

In the present invention, R₂ and R₃ are each independently a substituted or unsubstituted alkylaryl group. That is to say, each of R₂ and R₃ could be any of substituted or unsubstituted alkylphenyl groups, substituted or unsubstituted alkylnaphthyl groups, substituted or unsubstituted alkylheteroaryl groups and the like.

In the present invention, R₂ and R₃ are each independently anyone selected from the group consisting of

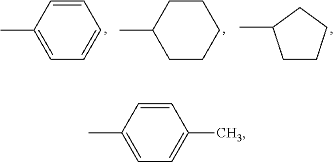

—CH₂CH₃, and —CH₃, wherein R₂ and R₃ could be identical or different from each other.

In the present invention, R₄ is selected from the group consisting of any organic groups of C₁-C₂₀ satisfying the chemical environment thereof. That is to say, R₄ is any organic group of C₁, C₂, C₃, C₄, C₅, C₆, C₇, C₈, C₉, C₁₀, C₁₁, C₁₂, C₁₃, C₁₄, C₁₅, C₁₆C₁₇, C₁₈, C₁₉ or C₂₀ satisfying the chemical environment thereof. Said organic group could be any organic group containing heteroatoms (e.g. N, O or F), or containing no heteroatoms, e.g. any alkyl group, cycloalkyl group, aryl group or heteroaryl group and the like satisfying said carbon atom number.

In the present invention, n₁ and n₂ are integers greater than 0, satisfying 4≤n₁+n₂≤25. n₁ could be 1, 2, 3, 4, 5, 6, 7, 8, 9, 10, 11, 12, 13, 14, 15, 16, 17, 18, 19, 20, 22, 23 or 24; n₂ could be 1, 2, 3, 4, 5, 6, 7, 8, 9, 10, 11, 12, 13, 14, 15, 16, 17, 18, 19, 20, 22, 23 or 24, satisfying 4≤n₁+n₂≤25. For example, n₁+n₂ is equal to 5, 6, 7, 8, 9, 10, 11, 12, 13, 14, 15, 16, 17, 18, 19, 20, 21, 22, 23 or 24, preferably 6≤n₁+n₂≤20, further preferably 8≤n₁+n₂≤15.

Preferably, the styryl siloxy polyphenylene ether resin is anyone selected from the group consisting of the compounds having the structures of Formulae a-d, and a combination of at least two selected therefrom,

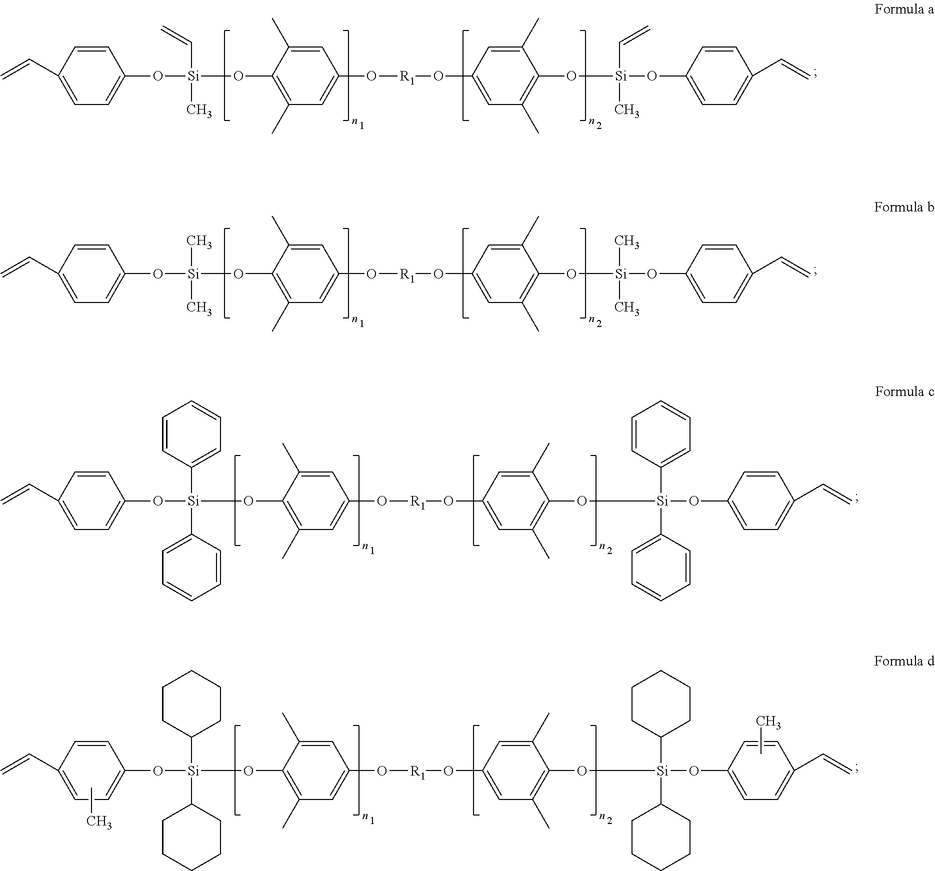

wherein R₁ is

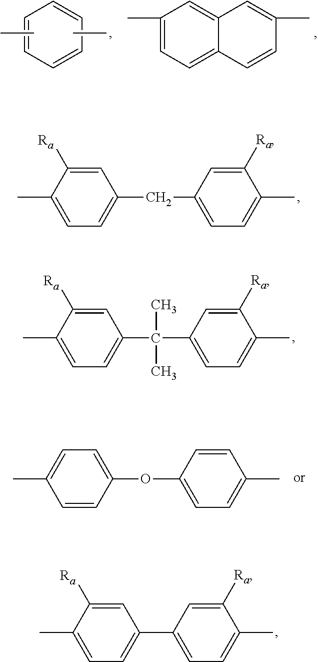

wherein Rₐ is anyone selected from the group consisting of H, allyl and isoallyl; n₁ and n₂ are integers greater than 0, satisfying 4≤n₁+n₂≤25.

On the second aspect, the present invention provides a preparation method for the styryl siloxy polyphenylene ether resin as stated above, wherein the method comprises the following steps:

(1) reacting dichlorosilane monomer as shown in Formula II with polyphenylene ether resin as shown in Formula III to obtain modified polyphenylene ether resin as shown in Formula IV, wherein the reaction formula is as follows:

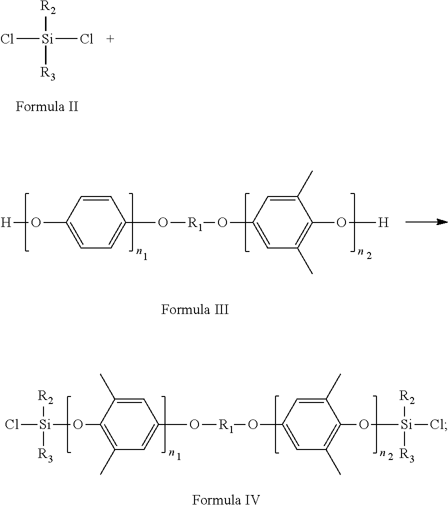

(2) reacting the modified polyphenylene ether resin as shown in Formula IV obtained in step (1) with phenolic monomer with vinyl group as shown in Formula V to obtain the styryl siloxy polyphenylene ether resin as shown in Formula I, wherein the reaction formula is as follows:

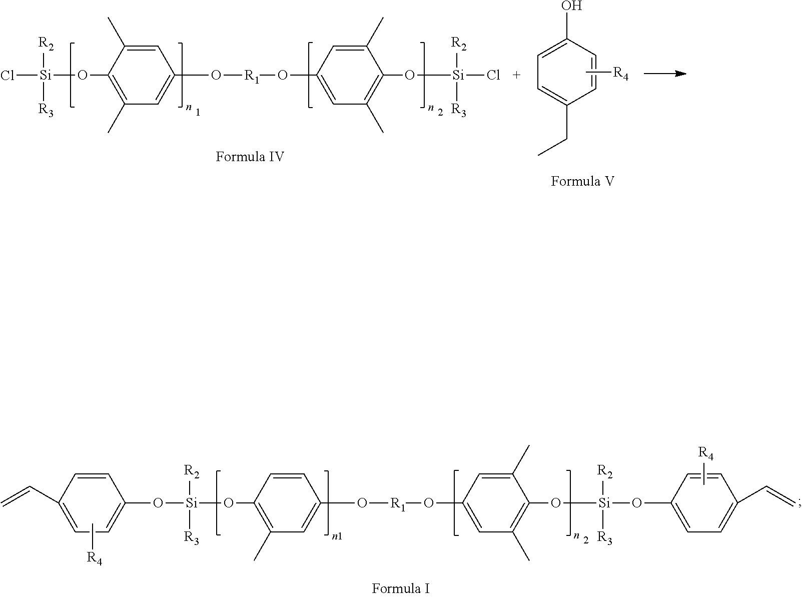

wherein R₁ is

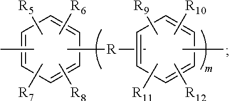

R is a covalent bond or anyone selected from the group consisting of substituted or unsubstituted C₁-C₈ linear chain alkyl groups, substituted or unsubstituted C₁-C₈ branched chain alkyl groups, —O—, —S—,

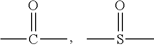

and —SO₂—; R₅, R₆, R₇, R₈, R₉, R₁₀, R₁₁ and R₁₂ are each independently anyone selected from the group consisting of hydrogen, substituted or unsubstituted C₁-C₈ linear chain alkyl groups, substituted or unsubstituted C₁-C₈ branched chain alkyl groups, substituted or unsubstituted C₂-C₁₀ linear chain alkenyl groups, substituted or unsubstituted C₂-C₁₀ branched chain alkenyl groups, and substituted or unsubstituted phenyl group; m is 0 or 1; R₂ and R₃ are each independently anyone selected from the group consisting of substituted or unsubstituted C₁-C₁₀ linear chain alkyl groups, substituted or unsubstituted C₁-C₁₀ branched chain alkyl groups, substituted or unsubstituted C₂-C₁₀ linear chain alkenyl groups, substituted or unsubstituted C₂-C₁₀ branched chain alkenyl groups, substituted or unsubstituted cycloalkyl groups, substituted or unsubstituted aryl groups and substituted or unsubstituted alkylaryl groups; R₄ is selected from the group consisting of hydrogen and any organic groups of C₁-C₂₀ satisfying the chemical environment thereof; n₁ and n₂ are integers greater than 0, satisfying 4≤n₁+n₂≤25.

Preferably, the dichlorosilane monomer as shown in Formula II and the polyphenylene ether resin as shown in Formula III have a phenol hydroxyl molar ratio of (1-1.5):1, e.g. 1:1, 1.1:1, 1.2:1, 1.3:1, 1.4:1 or 1.5:1.

Preferably, the reaction temperature in step (1) ranges from 0° C. to 60° C., e.g. 0° C., 5° C., 10° C., 15° C., 20° C., 25° C., 30° C., 35° C., 40° C., 45° C., 50° C., 55° C. or 60° C.

Preferably, the reaction time in step (1) ranges from 2 h to 24 h, e.g. 2 h, 3 h, 5 h, 6 h, 7 h, 9 h, 11 h, 13 h, 15 h, 16 h, 17 h, 19 h, 20 h, 22 h or 24 h, preferably 3-22 h, further preferably 4-20 h.

Preferably, in step (1), the dichlorosilane monomer as shown in Formula II is added dropwise into the reaction system comprising the polyphenylene ether resin as shown in Formula III.

Preferably, the temperature of the dropwise addition ranges from 0° C. to 20° C., e.g. 0° C., 3° C., 5° C., 8° C., 10° C., 12° C., 15° C., 18° C. or 20° C.

Preferably, the following is to react for 5-10 h (e.g. 5 h, 6 h, 7 h, 8 h, 9 h or 10 h) at 0-20° C. (e.g. 0° C., 3° C., 5° C., 8° C., 10° C., 12° C., 15° C., 18° C. or 20° C.) after dropwise addition of the dichlorosilane monomer as shown in Formula II, and then to heat to 40-60° C. (e.g. 40° C., 45° C., 50° C., 55° C. or 60° C.) and to react for 1-5 h (e.g. 1 h, 2 h, 3 h, 4 h or 5 h).

Preferably, in step (2), the phenolic monomer with vinyl group as shown in Formula V and Cl group in the modified polyphenylene ether resin as shown in Formula IV have a molar ratio of (0.65-1):1, e.g. 0.65:1, 0.7:1, 0.75:1, 0.8:1, 0.85:1, 0.9:1, 0.95:1 or 1:1.

Preferably, the reaction temperature in step (2) ranges from 0° C. to 60° C., e.g. 0° C., 5° C., 10° C., 15° C., 20° C., 25° C., 30° C., 35° C., 40° C., 45° C., 50° C., 55° C. or 60° C.

Preferably, the reaction time in step (2) ranges from 2 h to 10 h, e.g. 2 h, 3 h, 4 h, 5 h, 6 h, 7 h, 8 h, 9 h or 10 h, preferably 3-9 h, further preferably 4-8 h.

Preferably, the reactions in steps (1) and (2) are carried out in anhydrous organic solvents.

Preferably, the anhydrous organic solvent is anyone selected from the group consisting of tetrahydrofuran, dichloromethane, acetone, butanone, and a mixture of at least two selected therefrom. The typical but non-limiting examples of said mixture are selected from the group consisting of a mixture of tetrahydrofuran and dichloromethane, a mixture of dichloromethane and butanone, a mixture of tetrahydrofuran and butanone, and a mixture of acetone, tetrahydrofuran and butanone.

Preferably, the reactions in steps (1) and (2) are carried out under the protection of a protective gas, wherein the protective gas is preferably nitrogen gas.

On the third aspect, the present invention provides a styryl siloxy polyphenylene ether resin composition, comprising the styryl siloxy polyphenylene ether resin as stated above.

Preferably, the styryl siloxy polyphenylene ether resin has a weight percent content of 10-97% in the styryl siloxy polyphenylene ether resin composition, e.g. 12%, 15%, 18%, 20%, 25%, 28%, 30%, 35%, 40%, 45%, 50%, 55%, 60%, 65%, 70%, 75%, 80%, 85%, 90% or 95%.

Those skilled in the art can select other components in the styryl siloxy polyphenylene ether resin composition as needed.

Preferably, the styryl siloxy polyphenylene ether resin composition further comprises other resins having double bonds.

In the present invention, said other resins having double bonds refer to other resins having double bonds than said styryl siloxy polyphenylene ether resin.

Preferably, said other resins having double bonds are selected from the group consisting of polyolefin resins and organic silicone resins with double bonds.

Preferably, the polyolefin resins are anyone selected from the group consisting of styrene-butadiene copolymer, polybutadiene, styrene-butadiene-divinylbenzene copolymer, and a mixture of at least two selected therefrom.

Preferably, the polyolefin resins are anyone selected from the group consisting of amino-modified, maleic anhydride-modified, epoxy-modified, acrylate-modified, hydroxyl-modified or carboxyl-modified styrene-butadiene copolymer, polybutadiene, styrene-butadiene-divinylbenzene copolymer, and a mixture of at least two selected therefrom, e.g. styrene-butadiene copolymer R100 from Sartomer, polybutadiene B-1000 from Nippon Soda and styrene-butadiene-divinylbenzene copolymer R250 from Sartomer.

Preferably, the organic silicone resins with double bonds are anyone selected from the group consisting of organic silicone compounds of Formulae A and B, and a combination of at least two selected therefrom,

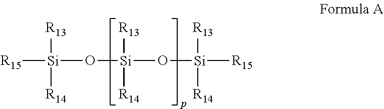

wherein R₁₃, R₁₄ and R₁₅ are each independently selected from the group consisting of substituted or unsubstituted C₁-C₈ linear chain alkyl groups, substituted or unsubstituted C₁-C₈ branched chain alkyl groups, substituted or unsubstituted phenyl group and substituted or unsubstituted C₂-C₁₀ alkenyl groups; at least one of R₁₃, R₁₄ and R₁₅ is substituted or unsubstituted C₂-C₁₀ alkenyl groups; p is an integer of 0-100;

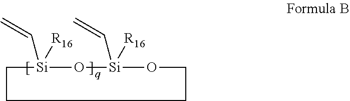

wherein R₁₆ is selected from the group consisting of substituted or unsubstituted C₁-C₁₂ linear chain alkyl groups and substituted or unsubstituted C₁-C₁₂ branched chain alkyl groups; q is an integer of 2-10.

Preferably, the styryl siloxy polyphenylene ether resin composition further comprises a silicon-hydrogen resin.

Preferably, the silicon-hydrogen resin is anyone selected from the group consisting of organosilicon compounds having silicon-hydrogen bonds as shown in Formulae C and D, and a combination of at least two selected therefrom;

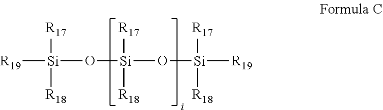

wherein R₁₇, R₁₈ and R₁₉ are each independently selected from the group consisting of substituted or unsubstituted C₁-C₈ linear chain alkyl groups, substituted or unsubstituted C₁-C₈ branched chain alkyl groups, substituted or unsubstituted phenyl group and hydrogen; at least one of R₁₇, R₁₈ and R₁₉ is hydrogen; i is an integer of 0-100;

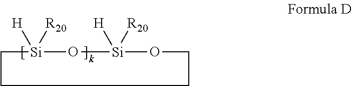

wherein R₂₀ is selected from the group consisting of substituted or unsubstituted C₁-C₁₂ linear chain alkyl groups and substituted or unsubstituted C₁-C₁₂ branched chain alkyl groups; k is an integer of 2-10.

Preferably, the styryl siloxy polyphenylene ether resin composition further comprises an initiator or a platinum catalyst.

In the present invention, the composition may comprise an initiator when the resins in the resin composition are all the styryl siloxy polyphenylene ether resin, or the styryl siloxy polyphenylene ether resin and other resins with double bonds. When the resin composition comprises a silicon-hydrogen resin, the composition may comprise a platinum catalyst as the catalyst.

Preferably, the initiator is a free-radical initiator selected from organic peroxide initiators.

Preferably, the organic peroxide initiators are anyone selected from the group consisting of di-tert-butyl peroxide, dilauroyl peroxide, dibenzoyl peroxide, cumyl peroxyneodecanoate, tert-butyl peroxyneodecanoate, tert-amyl peroxypivalate, tert-butyl peroxypivalate, tert-butyl peroxyisobutyrate, tert-butylperoxy-3,5,5-trimethylhexanoate, tert-butylperoxyacetate, tert-butyl peroxybenzoate, 1,1-di-tert-butylperoxy-3,5,5-trimethylcyclohexane, 1,1-di-tert-butylperoxycyclohexane, 2,2-di(tert-butylperoxy)-butane, bis(4-tert-butylcyclohexyl)peroxydicarbonate, dicetyl peroxydicarbonate, ditetradecyl peroxydicarbonate, di-tert amyl peroxide, diisopropylbenzene peroxide, bis(tert-butylperoxyisopropyl)benzene, 2,5-dimethyl-2,5-di-tert-butylperoxy-hexane, 2,5-dimethyl-2,5-di-tert-butylperoxyhexyne, diisopropylbenzene hydroperoxide, cumene hydroperoxide, tert-pentyl hydroperoxide, tert-butyl hydroperoxide, tert-butylperoxy cumene, diisopropylbenzene hydroperoxide, peroxy-carbonate-tert-butyl-2-ethylhexanoate, tert-butyl-2-ethylhexyl peroxycarbonate, n-butyl-4,4-di(tert-butylperoxy)pentanoate, methyl ethyl ketone peroxide, cyclohexane peroxide, and a mixture of at least two selected therefrom.

Preferably, the styryl siloxy polyphenylene ether resin composition further comprises an inorganic filler.

Preferably, the inorganic filler is anyone selected from the group consisting of aluminum hydroxide, boehmite, silica, talcum powder, mica, barium sulfate, lithopone, calcium carbonate, wollastonite, kaolin, brucite, diatomaceous earth, bentonite, pumice powder, and a mixture of at least two selected therefrom.

Preferably, the styryl siloxy polyphenylene ether resin composition further comprises a flame retardant.

Preferably, the flame retardant is an organic flame retardant and/or an inorganic flame retardant.

Preferably, the organic flame retardant is anyone selected from the group consisting of a halogen-based organic flame retardant, a phosphorus-based organic flame retardant, a nitrogen-based organic flame retardant, and a mixture of at least two selected therefrom.

Preferably, the organic flame retardant is anyone selected from the group consisting of tris(2,6-dimethylphenyl)phosphine, 10-(2,5-dihydroxyphenyl)-9,10-dihydro-9-oxa-10-phosphaphenanthrene-10-oxide, 2,6-bis(2,6-dimethylphenyl)-phosphino-benzene, 10-phenyl-9,10-dihydro-9-oxa-10-phosphaphenanthrene-10-oxide, a phenoxyphosphonitrile compound, a nitrogen-phosphorus expanded organic flame retardant, a phosphorus-containing phenolic resin, a phosphorus-containing bismaleimide, and a mixture of at least two selected therefrom.

Preferably, the inorganic flame retardant is zinc borate.

As one of the methods for preparing the styryl siloxy polyphenylene ether resin composition of the present invention, it can be prepared by stirring and mixing the components thereof through a known method.

On the fourth aspect, the present invention provides a resin varnish obtained by dissolving or dispersing the styryl siloxy polyphenylene ether resin composition as stated above in a solvent.

There are no specific limitations for the solvents of the present invention. As specific examples, said solvents are one selected from the group consisting of alcohols, ketones, aromatic hydrocarbons, ethers, esters, nitrogen-containing organic solvents, and a combination of at least two selected therefrom, preferably methanol, ethanol, butanol, ethyl cellosolve, butyl cellosolve, ethylene glycol-methyl ether, carbitol, butyl carbitol, acetone, butanone, methyl ethyl ketone, methyl isobutyl ketone, cyclohexanone, toluene, xylene, mesitylene, ethoxyethyl acetate, ethyl acetate, N,N-dimethylformamide, N,N-dimethylacetamide, N-methyl-2-pyrrolidone, and a mixture of at least two selected therefrom. Said solvents can be used separately, or in combination of two or more, preferably a mixture of an aromatic hydrocarbon solvent and a ketone solvent, preferably a mixture of toluene and/or xylene and anyone selected from the group consisting of acetone, butanone, methyl ethyl ketone, methyl isobutyl ketone, cyclohexanone, and a combination of at least two selected therefrom.

As to the amount of said solvents in the present invention, those skilled in the art can select according to their experience to make the resultant resin varnish reach a viscosity suitable for use.

During the process of dissolving or dispersing the resin composition above in the solvent, an emulsifying agent may be added. The dispersion could be made through the emulsifying agent to make the inorganic filler disperse homogeneously in the varnish.

On the fifth aspect, the present invention provides a cured product obtained by curing the styryl siloxy polyphenylene ether resin composition as stated above.

On the sixth aspect, the present invention provides a prepreg obtained by impregnating a reinforcing material with the resin varnish as stated above and drying it.

The reinforcing material is selected from the group consisting of carbon fiber, glass fiber cloth, aramid fiber and nonwoven fabric. Carbon fiber includes, for example, T300, T700, T800 from Toray Corporation of Japan, aramid fiber includes, for example, Kevlar fibers, and exemplary glass fiber cloth includes, for example, 7628 fiberglass cloth or 2116 fiberglass cloth.

On the seventh aspect, the present invention provides an insulating board comprising at least one prepreg as stated above.

On the eighth aspect, the present invention provides a metal foil-clad laminate, comprising at least one prepreg above and metal foils coated onto one or both sides of laminated prepregs.

The preparation method of metal foil-clad laminates (e.g. copper clad laminates) is existing technologies, and those skilled in the art are fully capable of preparing the metal foil-clad laminates of the present invention according to the preparation methods of metal foil-clad laminates disclosed in the prior art. When the metal foil-clad laminate is applied to the preparation of a printed circuit board, it has superior electrical properties and meets the requirements of high speed and high frequency.

On the ninth aspect, the present invention provides a high-frequency circuit substrate comprising at least one prepreg as stated above.

As compared with the prior art, the present invention has the following beneficial effects.

The present invention discloses introducing styryl groups and siloxy groups into polyphenylene ether end groups to obtain the styryl siloxy polyphenylene ether resin. The resin simultaneously combines low dielectric properties of curing of styryl groups with heat resistance, weatherability, flame retardancy, dielectric properties and low water absorption of siloxy groups, thereby making better use of the application advantages of polyphenylene ether resin in copper clad laminates and providing excellent dielectric properties, moist-heat resistance and heat resistance required by high-frequency and high-speed copper clad laminates.

### EMBODIMENTS

The technical solutions of the present invention will be further described below through specific embodiments. Those skilled in the art shall know that the described examples are used only for understanding the present invention and should not be construed as particularly limiting the present invention.

### EXAMPLE 1

73 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 19.5 parts by weight of diphenyldichlorosilane was slowly added dropwise. After completion of the dropwise addition, the reactor was maintained at a temperature of 20° C. or lower for 8 hours, and then the temperature was raised to 55° C. for 3 hours. Subsequently, 7.5 parts by weight of p-hydroxystyrene was added dropwise to the reactor and reacted at 55° C. for 5 hours. After completion of the reaction, tetrahydrofuran was removed by vacuum distillation, to obtain a styryl siloxy-modified polyphenylene ether resin marked as Resin a.

### EXAMPLE 2

80 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 12 parts by weight of methylvinyldichlorosilane was slowly added dropwise. After completion of the dropwise addition, the reactor was maintained at a temperature of 20° C. or lower for 8 hours, and then the temperature was raised to 55° C. for 3 hours. Subsequently, 8 parts by weight of p-hydroxystyrene was added dropwise to the reactor and reacted at 55° C. for 5 hours. After completion of the reaction, tetrahydrofuran was removed by vacuum distillation, to obtain a styryl siloxy-modified polyphenylene ether resin marked as Resin b.

### EXAMPLE 3

80 parts by weight of polyphenylene ether resin MX90 and 1000 mL of anhydrous tetrahydrofuran were stirred in a reactor equipped with a stirrer, a dropping funnel, a thermometer and a gas pipe (nitrogen gas) until completely dissolved into a uniform solution. Continuous nitrogen gas was supplied for 0.5-1 h to remove the water vapor in the reactor. Nitrogen gas was maintained throughout the reaction. The temperature in the reactor was kept below 20° C., and then 11 parts by weight of dimethyldichlorosilane was slowly added dropwise. After completion of the dropwise addition, the reactor was maintained at a temperature of 20° C. or lower for 9 hours, and then the temperature was raised to 50° C. for 4 hours. Subsequently, 9 parts by weight of p-hydroxystyrene was added dropwise to the reactor and reacted at 52° C. for 6 hours. After completion of the reaction, tetrahydrofuran was removed by vacuum distillation, to obtain a styryl siloxy-modified polyphenylene ether resin marked as Resin c.

### EXAMPLE 4

80 parts by weight of the styryl siloxy-modified polyphenylene ether resin (Resin a) prepared in Example 1 and 20 parts by weight of phenyl silicon-hydrogen resin SH303 were dissolved in an appropriate amount of butanone solvent and adjusted to an appropriate viscosity. A platinum catalyst in a total amount of 10 ppm was added and stirred well. Gas was pumped under vacuum for a period of time to remove air bubbles and butanone in the varnish system. The processed varnish was poured into a mold and placed at 50° C. for 1 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 5

79 parts by weight of the styryl siloxy-modified polyphenylene ether resin (Resin b) prepared in Example 2 and 21 parts by weight of phenyl silicon-hydrogen resin SH303 were dissolved in an appropriate amount of butanone solvent and adjusted to an appropriate viscosity. A platinum catalyst in a total amount of 10 ppm was added and stirred well. Gas was pumped under vacuum for a period of time to remove air bubbles and butanone in the varnish system. The processed varnish was poured into a mold and placed at 50° C. for 1 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 6

79 parts by weight of the styryl siloxy-modified polyphenylene ether resin (Resin c) prepared in Example 2 and 21 parts by weight of phenyl silicon-hydrogen resin SH303 were dissolved in an appropriate amount of butanone solvent and adjusted to an appropriate viscosity. A platinum catalyst in a total amount of 10 ppm was added and stirred well. Gas was pumped under vacuum for a period of time to remove air bubbles and butanone in the varnish system. The processed varnish was poured into a mold and placed at 50° C. for 1 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 7

97 parts by weight of the styryl siloxy-modified polyphenylene ether resin (Resin b) prepared in Example 2 and 3 parts by weight of dicumyl peroxide (DCP) were dissolved in an appropriate amount of butanone solvent and adjusted to an appropriate viscosity. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 8

97 parts by weight of the styryl siloxy-modified polyphenylene ether resin (Resin b) prepared in Example 2 and 3 parts by weight of dicumyl peroxide (DCP) were dissolved in an appropriate amount of butanone solvent and adjusted to an appropriate viscosity. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 9

97 parts by weight of the styryl siloxy-modified polyphenylene ether resin (Resin c) prepared in Example 3 and 3 parts by weight of dicumyl peroxide (DCP) were dissolved in an appropriate amount of butanone solvent and adjusted to an appropriate viscosity. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 10

77 parts by weight of the styryl siloxy-modified polyphenylene ether resin (Resin c) prepared in Example 3, 20 parts by weight of butadiene-styrene copolymer Ricon100 and 3 parts by weight of dicumyl peroxide (DCP) were dissolved in an appropriate amount of butanone solvent, adjusted to an appropriate viscosity and homogeneously stirred. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 11

20 parts by weight of the styryl siloxy-modified polyphenylene ether resin (Resin c) prepared in Example 3, 77 parts by weight of butadiene-styrene copolymer Ricon100 and 3 parts by weight of dicumyl peroxide (DCP) were dissolved in an appropriate amount of butanone solvent, adjusted to an appropriate viscosity and homogeneously stirred. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 1.

### EXAMPLE 12

77 parts by weight of the styryl siloxy-modified polyphenylene ether resin (Resin c) prepared in Example 3, 20 parts by weight of butadiene-styrene copolymer Ricon100 and 3 parts by weight of dicumyl peroxide (DCP) were dissolved in an appropriate amount of butanone solvent, adjusted to an appropriate viscosity and homogeneously stirred.

A 2116 glass fiber cloth was impregnated with the above varnish, and then dried to remove the solvent to obtain a prepreg. Two prepregs thus formed were laminated, and pressed onto both sides thereof with copper foils having a thickness of ½ oz (ounce). Curing was carried out for 130 minutes in a press at a curing pressure of 60 kg/cm² and a curing temperature of 200° C. to obtain a copper clad laminate.

### EXAMPLE 13

97 parts by weight of the styryl siloxy-modified polyphenylene ether resin (Resin c) prepared in Example 3 and 3 parts by weight of dicumyl peroxide (DCP) were dissolved in an appropriate amount of butanone solvent, adjusted to an appropriate viscosity and homogeneously stirred.

A 1080 glass fiber cloth was impregnated with the above varnish, and then dried to remove the solvent to obtain a prepreg. Three prepregs thus formed were laminated, and pressed onto both sides thereof with release films. Curing was carried out for 2 h in a press at a curing pressure of 50 kg/cm² and a curing temperature of 190° C. to obtain a laminate.

### COMPARISON EXAMPLE 1

10 ppm of a platinum catalyst was added to 61 parts by weight of vinylphenyl silicon resin and 39 parts by weight of phenyl silicon-hydrogen resin, and homogeneously stirred. Gas was pumped under vacuum for a period of time to remove air bubbles and butanone in the varnish system. The processed varnish was poured into a mold and placed at 50° C. for 5 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 2.

### COMPARISON EXAMPLE 2

97 parts by weight of methacrylate-based polyphenylene ether resin MX9000 and 3 parts by weight of dicumyl peroxide (DCP) were dissolved in an appropriate amount of butanone solvent, adjusted to an appropriate viscosity and homogeneously stirred. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resultant cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 2.

### COMPARISON EXAMPLE 3

77 parts by weight of methacrylate-based polyphenylene ether resin MX9000, 20 parts by weight of butadiene-styrene copolymer Ricon100 and 3 parts by weight of dicumyl peroxide (DCP) were dissolved in an appropriate amount of butanone solvent, adjusted to an appropriate viscosity and homogeneously stirred. Gas was pumped under vacuum for a period of time to remove air bubbles and butanone in the varnish system. The processed varnish was poured into a mold and placed at 120° C. for 2 h. After the molding, the mold was vacuum laminated and cured in a press for 90 minutes at a curing pressure of 32 kg/cm² and a curing temperature of 200° C., to obtain a flake cured product having a thickness of 0.5-2.0 mm. For the resulted cured product, the dielectric constant and dielectric loss factor thereof were measured at 23° C. and 1 GHz by the plate capacitance method. The temperature at 5% weight loss (Td 5%) under a nitrogen atmosphere was evaluated by TGA at a temperature increasing rate of 10° C./min. The glass transition temperature was tested by DMA. The performance test results are shown in Table 2.

Specific materials in the Examples and Comparison Examples are listed as follows.

Methacrylate-based polyphenylene ether resin: MX9000, Sabic.

Butadiene-styrene copolymer: Ricon100, Sartomer.

Dicumyl peroxide: Shanghai Gaoqiao.

Phenyl silicon-hydrogen resin: SH303, Runhe Chemical.

Vinylphenyl silicon Resin: SP606, Runhe Chemical.

The measuring criteria or methods for the parameters in Table 1 are as follows:

(1) Glass transition temperature (Tg): tested by DMA and determined according to the DMA test method specified in IPC-TM-650 2.4.24.4;

(2) Dielectric constant and dielectric loss factor: tested in accordance with IPC-TM-650 2.5.5.9 with the test frequency of 1 GHz;

(3) Thermal Decomposition Temperature (Td 5%): determined by the TGA method specified in IPC-TM-650 2.4.24 according to the thermogravimetric analysis (TGA);

(4) Flammability: determined according to the flammability method specified in UL94; and

(5) Water absorption: determined according to the water absorption method specified in IPC-TM-60 2.6.2.1.

TABLE 1

| | Examples | | | | | | | |
|---|---|---|---|---|---|---|---|---|
| Performances | 4 | 5 | 6 | 7 | 8 | 9 | 10 | 11 |
| Dielectric | 2.36 | 2.38 | 2.33 | 2.40 | 2.38 | 2.37 | 2.41 | 2.35 |
| constant | | | | | | | | |
| (1 GHz) | | | | | | | | |
| Dielectric | 0.0039 | 0.0033 | 0.0040 | 0.0032 | 0.0034 | 0.0035 | 0.0037 | 0.0038 |
| loss | | | | | | | | |
| (1 GHz) | | | | | | | | |
| Tg (° C.) | 219.0 | 214.7 | 217.3 | 206.6 | 209.0 | 203.3 | 203.2 | 190.5 |
| Td (5%) | 465.8 | 477.4 | 476.5 | 429.3 | 439.5 | 440.0 | 425.6 | 423.2 |
| Water | 0.05 | 0.05 | 0.05 | 0.05 | 0.05 | 0.05 | 0.05 | 0.05 |
| absorption | | | | | | | | |
| Flammability | V-1 | V-1 | V-1 | V-1 | V-1 | V-1 | V-1 | V-2 |

TABLE 2

| | Comparison Examples | | |
|---|---|---|---|
| Performances | 1 | 2 | 3 |
| Dielectric constant | 2.76 | 2.93 | 3.06 |
| (1 GHz) | | | |
| Dielectric loss | 0.0063 | 0.0105 | 0.0078 |
| (1 GHz) | | | |
| Tg (° C.) | 157.7 | 212.7 | 198.6 |
| Td (5%) | 589.9 | 375.0 | 398.5 |
| Water absorption | 0.05 | 0.06 | 0.05 |
| Flammability | V-0 | V-1 | V-1 |

According to Table 1 above, it can be seen that the cured product prepared from the composition of the styryl siloxy polyphenylene ether resin of the present invention has a dielectric constant (1 GHz) of 2.33 to 2.41 and a dielectric loss (1 GHz) of 0.0032 to 0.0040, a glass transition temperature Tg of up to 190° C. or higher, a thermal decomposition temperature of up to 425° C. or higher, a flame retardancy which can reach V-1 level, and a water absorption rate less than 0.05%. It has low dielectric properties, high heat resistance, better flame retardancy and low water absorption rate.

According to the comparisons between Tables 1 and 2, Examples 4-6 show that, as compared to general vinyl phenyl silicone resins (Comparison Example 1), the cured product of the resin composition comprising the styryl siloxy-modified polyphenylene ether resin synthesized according to the present invention has more excellent dielectric properties and a higher glass transition temperature. Examples 7-11 show that, as compared to methylacrylate-based polyphenylene ether resin (Comparison Examples 2 and 3), the styryl siloxy-modified polyphenylene ether resin synthesized according to the present invention also has more excellent dielectric properties, a higher glass transition temperature, and a higher thermal decomposition temperature. Therefore, the styryl siloxy-modified polyphenylene ether resin is a resin with more excellent comprehensive performances. It can be used for the preparation of high-frequency circuit substrates, and has great application value.

The applicant claims that the present invention describes the styryl siloxy polyphenylene ether resin, method for preparing the same and application thereof of the present invention through the examples, but the present invention is not limited to the examples above. That is to say, it does not mean that the present invention shall not be carried out unless the above-described examples are referred. Those skilled in the art shall know that any improvements to the present invention, equivalent replacements of the raw materials of the present invention, additions of auxiliary, selections of any specific ways all fall within the protection scope and disclosure scope of the present invention.

1-10. (canceled)

11. A styryl siloxy polyphenylene ether resin, wherein the styryl siloxy polyphenylene ether resin has a structure of Formula (I): 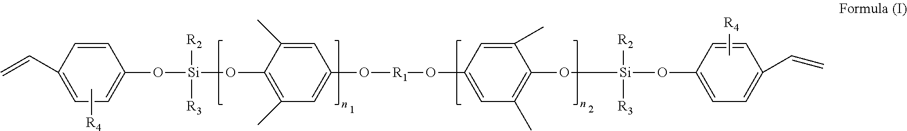
wherein R₁ is 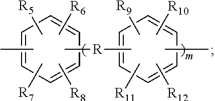
R is a covalent bond or anyone selected from the group consisting of substituted or unsubstituted C₁-C₈ linear chain alkyl groups, substituted or unsubstituted C₁-C₈ branched chain alkyl groups, —O—, —S—, 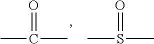
and —SO₂—; R₅, R₆, R₇, R₈, R₉, R₁₀, R₁₁ and R₁₂ are each independently anyone selected from the group consisting of hydrogen, substituted or unsubstituted C₁-C₈ linear chain alkyl groups, substituted or unsubstituted C₁-C₈ branched chain alkyl groups, substituted or unsubstituted C₂-C₁₀ linear chain alkenyl groups, substituted or unsubstituted C₂-C₁₀ branched chain alkenyl groups, and substituted or unsubstituted phenyl group; m is 0 or 1; R₂ and R₃ are each independently anyone selected from the group consisting of substituted or unsubstituted C₁-C₁₀ linear chain alkyl groups, substituted or unsubstituted C₁-C₁₀ branched chain alkyl groups, substituted or unsubstituted C₂-C₁₀ linear chain alkenyl groups, substituted or unsubstituted C₂-C₁₀ branched chain alkenyl groups, substituted or unsubstituted cycloalkyl groups, substituted or unsubstituted aryl groups and substituted or unsubstituted alkylaryl groups; R₄ is selected from the group consisting of hydrogen and any organic groups of C₁-C₂₀ satisfying the chemical environment thereof; n₁ and n₂ are integers greater than 0, satisfying 4≤n₁+n₂≤25.

12. The styryl siloxy polyphenylene ether resin claimed in claim 11, wherein R₁ is 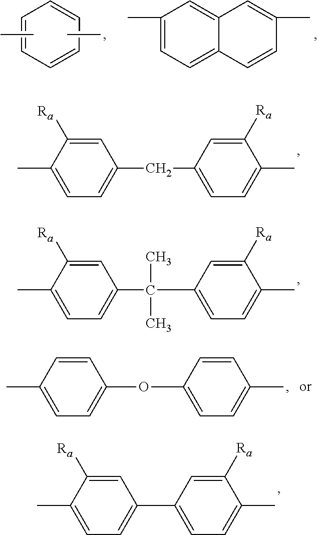
wherein Rₐ is anyone selected from the group consisting of H, allyl and isoallyl;
R₂ and R₃ are each independently anyone selected from the group consisting of 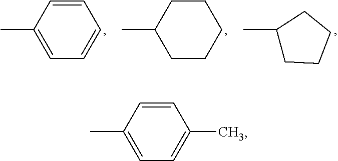
—CH₂CH₃ and —CH₃.

13. The styryl siloxy polyphenylene ether resin claimed in claim 11, wherein the styryl siloxy polyphenylene ether resin is anyone selected from the group consisting of the compounds having the structures of Formulae a-d, and a combination of at least two selected therefrom, 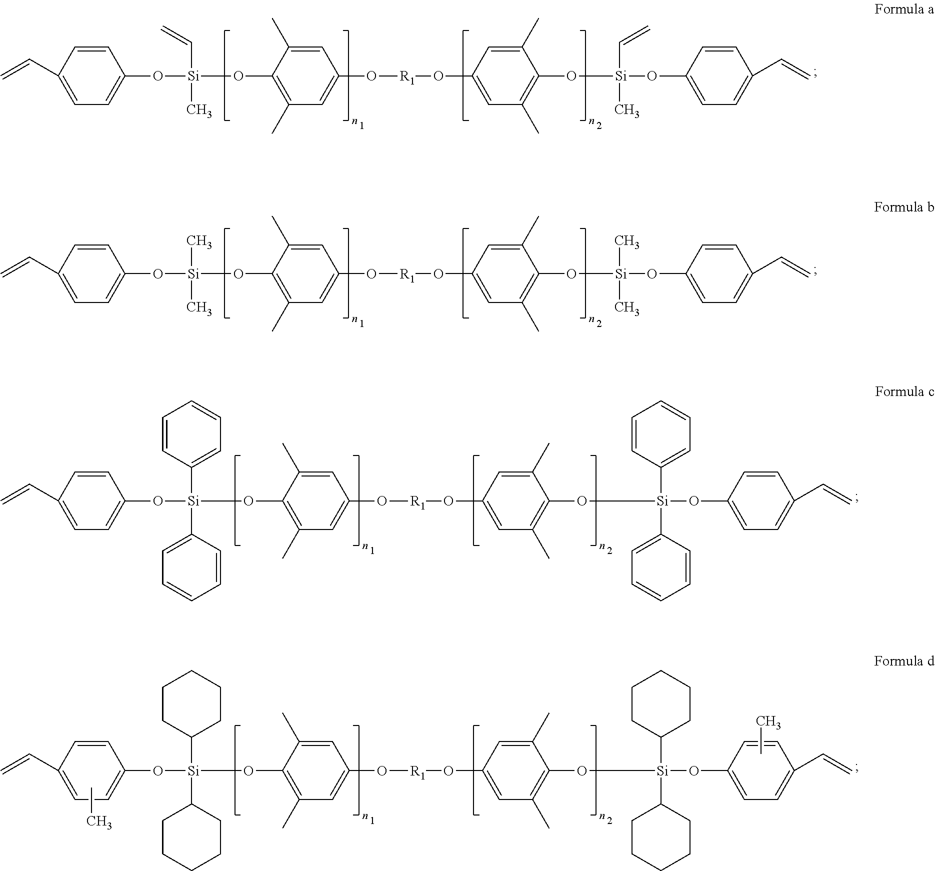
wherein R₁ is 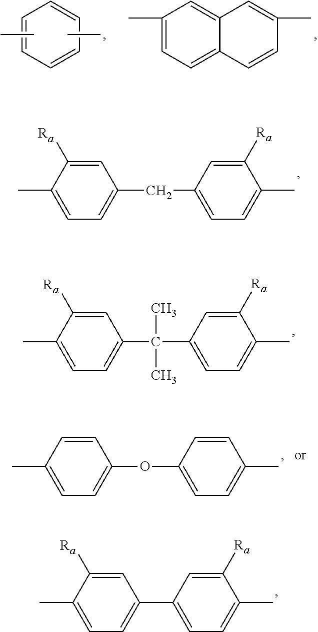
wherein Rₐ is anyone selected from the group consisting of H, allyl and isoallyl; n₁ and n₂ are integers greater than 0, satisfying 4≤n₁+n₂≤25.

14. A preparation method for the styryl siloxy polyphenylene ether resin claimed in claim 11, wherein the method comprises the following steps:
(1) reacting dichlorosilane monomer as shown in Formula II with polyphenylene ether resin as shown in Formula III to obtain modified polyphenylene ether resin as shown in Formula IV, wherein the reaction formula is as follows: 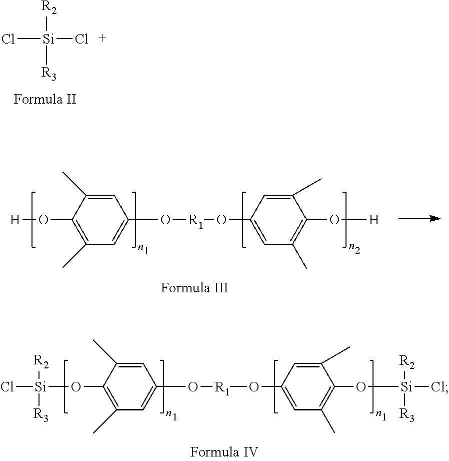
(2) reacting the modified polyphenylene ether resin as shown in Formula IV obtained in step (1) with phenolic monomer with vinyl group as shown in Formula V to obtain the styryl siloxy polyphenylene ether resin as shown in Formula I, wherein the reaction formula is as follows: 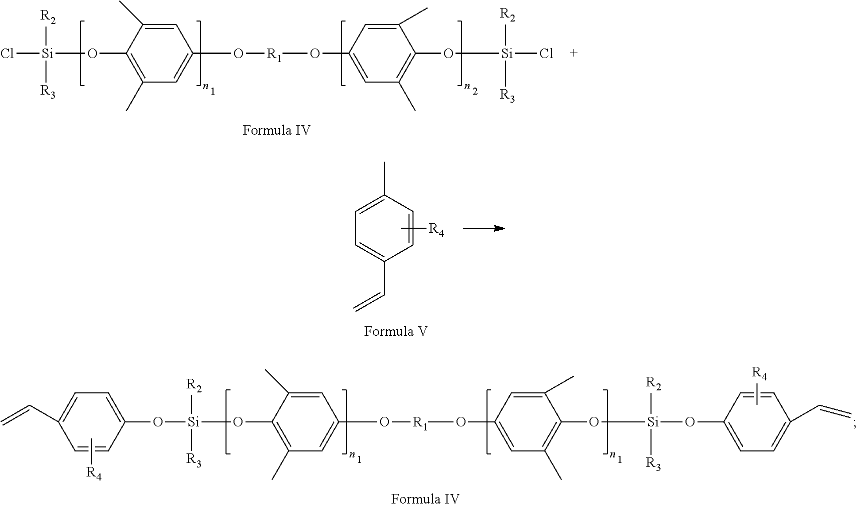
wherein R₁ is 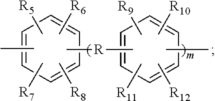
R is a covalent bond or anyone selected from the group consisting of substituted or unsubstituted C₁-C₈ linear chain alkyl groups, substituted or unsubstituted C₁-C₈ branched chain alkyl groups, —O—, —S—, 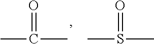
and —SO₂—; R₅, R₆, R₇, R₈, R_{9,} R₁₀, R₁₁ and R₁₂ are each independently anyone selected from the group consisting of hydrogen, substituted or unsubstituted C₁-C₈ linear chain alkyl groups, substituted or unsubstituted C₁-C₈ branched chain alkyl groups, substituted or unsubstituted C₂-C₁₀ linear chain alkenyl groups, substituted or unsubstituted C₂-C₁₀ branched chain alkenyl groups, and substituted or unsubstituted phenyl group; m is 0 or 1; R₂ and R₃ are each independently anyone selected from the group consisting of substituted or unsubstituted C₁-C₁₀ linear chain alkyl groups, substituted or unsubstituted C₁-C₁₀ branched chain alkyl groups, substituted or unsubstituted C₂-C₁₀ linear chain alkenyl groups, substituted or unsubstituted C₂-C₁₀ branched chain alkenyl groups, substituted or unsubstituted cycloalkyl groups, substituted or unsubstituted aryl groups and substituted or unsubstituted alkylaryl groups; R₄ is selected from the group consisting of hydrogen and any organic groups of C₁-C₂₀ satisfying the chemical environment thereof; n₁ and n₂ are integers greater than 0, satisfying 4≤n₁+n₂≤25.

15. The preparation method claimed in claim 14, wherein the dichlorosilane monomer as shown in Formula II and the polyphenylene ether resin as shown in Formula III have a phenol hydroxyl molar ratio of (1-1.5):1.

16. The preparation method claimed in claim 14, wherein the reaction temperature in step (1) ranges from 0° C. to 60° C.;
the reaction time in step (1) ranges from 2 h to 24 h.

17. The preparation method claimed in claim 14, wherein in step (1), the dichlorosilane monomer as shown in Formula II is added dropwise into the reaction system comprising the polyphenylene ether resin as shown in Formula III;
the temperature of the dropwise addition ranges from 0° C. to 20° C.;
the following is to react for 5-10 h at 0-20° C. after dropwise addition of the dichlorosilane monomer as shown in Formula II, and then to heat to 40-60° C. and to react for 1-5 h.

18. The preparation method claimed in claim 14, wherein in step (2), the phenolic monomer with vinyl group as shown in Formula V and Cl group in the modified polyphenylene ether resin as shown in Formula IV have a molar ratio of (0.65-1):1.

19. The preparation method claimed in claim 14, wherein the reaction temperature in step (2) ranges from 0° C. to 60° C.;
the reaction time in step (2) ranges from 2 h to 10 h.

20. The preparation method claimed in claim 14, wherein the reactions in steps (1) and (2) are carried out in anhydrous organic solvents;
the anhydrous organic solvent is anyone selected from the group selected form the group consisting of tetrahydrofuran, dichloromethane, acetone, butanone, and a mixture of at least two selected therefrom.

21. A styryl siloxy polyphenylene ether resin composition, wherein the styryl siloxy polyphenylene ether resin composition comprises the styryl siloxy polyphenylene ether resin claimed in claim 11;
the styryl siloxy polyphenylene ether resin has a weight percent content of 10-97% in the styryl siloxy polyphenylene ether resin composition.

22. The composition claimed in claim 21, wherein the styryl siloxy polyphenylene ether resin composition further comprises other resins having double bonds;
the other resins having double bonds are selected from the group consisting of polyolefin resins and organic silicone resins with double bonds.

23. The composition claimed in claim 22, wherein the polyolefin resins are anyone selected from the group consisting of styrene-butadiene copolymer, polybutadiene, styrene-butadiene-divinylbenzene copolymer, and a mixture of at least two selected therefrom.

24. The composition claimed in claim 22, wherein the organic silicone resins with double bonds are anyone selected from the group consisting of organic silicone compounds of Formulae A and B, and a combination of at least two selected therefrom, 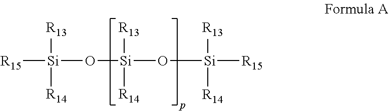
wherein R₁₃, R₁₄ and R₁₅ are each independently selected from the group consisting of substituted or unsubstituted C₁-C₈ linear chain alkyl groups, substituted or unsubstituted C₁-C₈ branched chain alkyl groups, substituted or unsubstituted phenyl group and substituted or unsubstituted C₂-C₁₀ alkenyl groups; at least one of R₁₃, R₁₄ and R₁₅ is substituted or unsubstituted C₂-C₁₀ alkenyl groups; p is an integer of 0-100; 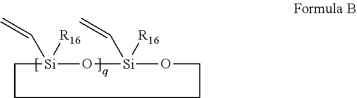
wherein R₁₆ is selected from the group consisting of substituted or unsubstituted C₁-C₁₂ linear chain alkyl groups and substituted or unsubstituted C₁-C₁₂ branched chain alkyl groups; q is an integer of 2-10.

25. The composition claimed in claim 21, wherein the styryl siloxy polyphenylene ether resin composition further comprises a silicon-hydrogen resin;
the silicon-hydrogen resin is anyone selected from the group consisting of organosilicon compounds having silicon-hydrogen bonds as shown in Formulae C and D, and a combination of at least two selected therefrom; 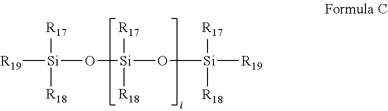
wherein R₁₇, R₁₈ and R₁₉ are each independently selected from the group consisting of substituted or unsubstituted C₁-C₈ linear chain alkyl groups, substituted or unsubstituted C₁-C₈ branched chain alkyl groups, substituted or unsubstituted phenyl group and hydrogen; at least one of R₁₇, R₁₈ and R₁₉ is hydrogen; i is an integer of 0-100; 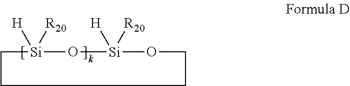
wherein R₂₀ is selected from the group consisting of substituted or unsubstituted C₁-C₁₂ linear chain alkyl groups and substituted or unsubstituted C₁-C₁₂ branched chain alkyl groups; k is an integer of 2-10.

26. The composition claimed in claim 21, wherein the styryl siloxy polyphenylene ether resin composition further comprises an initiator or a platinum catalyst.

27. The composition claimed in claim 26, wherein the initiator is a free-radical initiator selected from organic peroxide initiators;
the organic peroxide initiators are anyone selected from the group consisting of di-tert-butyl peroxide, dilauroyl peroxide, dibenzoyl peroxide, cumyl peroxyneodecanoate, tert-butyl peroxyneodecanoate, tert-amyl peroxypivalate, tert-butyl peroxypivalate, tert-butyl peroxyisobutyrate, tert-butylperoxy-3,5,5-trimethylhexanoate, tert-butyl peroxyacetate, tert-butyl peroxybenzoate, 1,1-di-tert-butylperoxy-3,5,5-trimethylcyclohexane, 1,1-di-tert-butylperoxycyclohexane, 2,2-di(tert-butylperoxy)-butane, bis(4-tert-butylcyclohexyl)peroxydicarbonate, dicetyl peroxydicarbonate, ditetradecyl peroxydicarbonate, di-tert amyl peroxide, diisopropylbenzene peroxide, bis(tert-butylperoxyisopropyl)benzene, 2,5-dimethyl-2,5-di-tert-butylperoxy-hexane, 2,5-dimethyl-2,5-di-tert-butylperoxyhexyne, diisopropylbenzene hydroperoxide, cumene hydroperoxide, tert-pentyl hydroperoxide, tert-butyl hydroperoxide, tert-butylperoxy cumene, diisopropylbenzene hydroperoxide, peroxy-carbonate-tert-butyl-2-ethylhexanoate, tert-butyl-2-ethylhexyl peroxycarbonate, n-butyl-4,4-di(tert-butylperoxy)pentanoate, methyl ethyl ketone peroxide, cyclohexane peroxide, and a mixture of at least two selected therefrom.

28. The composition claimed in claim 21, wherein the styryl siloxy polyphenylene ether resin composition further comprises an inorganic filler;
the inorganic filler is anyone selected from the group consisting of aluminum hydroxide, boehmite, silica, talcum powder, mica, barium sulfate, lithopone, calcium carbonate, wollastonite, kaolin, brucite, diatomaceous earth, bentonite, pumice powder, and a mixture of at least two selected therefrom.

29. The composition claimed in claim 21, wherein the styryl siloxy polyphenylene ether resin composition further comprises a flame retardant;
the flame retardant is an organic flame retardant and/or an inorganic flame retardant.

30. A resin varnish, characterized in that the resin varnish is obtained by dissolving or dispersing the styryl siloxy polyphenylene ether resin composition claimed in claim 21 in a solvent.

31. A prepreg, characterized in that the prepreg is obtained by impregnating a reinforcing material with the resin varnish claimed in claim 20 and drying it.

32. A metal foil-clad laminate, characterized in comprising at least one prepreg claimed in claim 31 and metal foils coated onto one or both sides of laminated prepregs.

33. A high-frequency circuit substrate, characterized in comprising at least one prepreg claimed in claim 31.
